(19) United States
(12) Patent Application Publication
(10) Pub. No.: US 2016/0019573 A1
(43) Pub. Date: Jan. 21, 2016

(54) DISCOUNT DEALS FOR POSITIVE SOCIAL MEDIA COMMUNICATIONS

(71) Applicant: Go Daddy Operations Company, LLC, Scottsdale, AZ (US)

(72) Inventor: Sandeep Grover, Sunnyvale, CA (US)

(21) Appl. No.: 14/333,935

(22) Filed: Jul. 17, 2014

(51) Int. Cl. G06Q 30/02; G06Q 50/00

(52) U.S. Cl. CPC G06Q 30/0217; G06Q 50/01

(57) ABSTRACT

A method is disclosed for a website, preferably having an e-commerce storefront, operated by a business to offer a customer a discount deal for a good or service in exchange for a positive social media communication from a social media account of the customer to a social media account of the business. If the customer accepts the discount deal, the website or e-commerce storefront may either access social media account login information previously received from the customer or request the social media account login information from the customer. The website or e-commerce storefront may then log into the social media account of the customer and transmit a positive social media communication (such as a follow or like) from the social media account of the customer to the social media account of the business.

### FIELD OF THE INVENTION

The present invention generally relates to the field of offering a customer a discount, either online or via a telephone communication, for a good or service in exchange for a positive social media communication.

### SUMMARY OF THE INVENTION

The present invention provides methods for a business to trade discounts for goods and services to customers in exchange for positive social media communications from customers. In some embodiments, a hosting provider may host a website for a business. The website may have an e-commerce storefront, preferably provided by the hosting provider although it may be provided by a third party, from which the business may sell goods and services.

The hosting provider may receive from the business a selected discount deal to offer for a good or service in exchange for a positive social media communication from a social media account of the customer to a social media account of the business. In preferred embodiments, the hosting provider may provide an administration interface for the business to select a discount deal for the good or service to offer on the e-commerce storefront to the customer in exchange for the positive social media communication from the social media account of the customer to the social media account of the business.

The selected discount deal may then be displayed to one or more customers on the e-commerce storefront. The website or e-commerce storefront may receive an acceptance of the discount deal from the customer if the customer desires to accept the discount deal in exchange for the positive social media communication. The website or e-commerce storefront may communicate the positive social media communication from the social media account of the customer to the social media account of the business.

This may be accomplished, as a non-limiting example, by the customer entering the customer's login credentials to the website or e-commerce storefront and the website or e-commerce storefront logging into the customer's social media account using the customer's login credentials. The website or e-commerce storefront may then communicate the positive social media communication from the customer's social media account to the business' social media account. The login credentials may comprise a user name and a password, as a non-limiting example. After communicating the positive social media communication, the website or e-commerce storefront may log out of the social media account of the customer.

Alternatively, the communication of the positive social media communication may be accomplished, as a non-limiting example, by having the customer's login credentials, previously received from the customer, stored in a database. The website or e-commerce storefront may then log into the social media account of the customer using the customer's login credentials and communicate the positive social media communication from the social media account of the customer to the social media account of the business.

In a preferred embodiment, a most frequently used social media account for the customer may be determined from a plurality of social media accounts of the customer. This may be determined from business analytic software operated by either the hosting provider or the business. The positive social media communication may then be communicated from the most frequently used social media account of the customer to the matching social media account of the business.

The positive social media communication may be selected from the possible types of interactions or exchanges permitted by the social media (platform). As non-limiting examples of a positive social media communication, a social media may permit a social media account to “like” or “follow” another social media account. However, the invention is not so limited and may use any positive social media communication permitted by the social media.

In another embodiment, a business may offer on its website a discount deal for a good or service to a customer in exchange for a positive social media communication from a social media account of the customer to a social media account of the business. In preferred embodiments, the website includes an e-commerce storefront. The website or e-commerce storefront may receive from the customer an acceptance of the discount deal. After receiving the acceptance, the website or e-commerce storefront may communicate the positive social media communication from the social media account of the customer to the social media account of the business and sell from the website the good or service to the customer according to the discount deal for the good or service.

As in the previous embodiment, a most frequently used social media account of the customer may be determined from a plurality of social media accounts of the customer. The positive social media communication from the most frequently used social media account of the customer may be communicated to the matching social media account of the business. As in other embodiments, the positive social media communication is only limited by the types of communications permitted by the social media and may comprise a like, a follow and/or a positive text and/or image message.

Also as discussed in the previous embodiment, the login credentials for the social media account of the customer may be received directly from the customer in real-time or may have been received from the customer in the past and stored in a database. The login credentials, whether read from the database or received in real-time, may then be used to log into the social media account of the customer and transmit the positive social media communication from the social media account of the customer to the social media account of the business.

In another embodiment, a telephone number for a customer and login credentials (such as a user account name and a password) for a social media account of the customer may be stored in a database. The telephone number and/or login credentials of the customer may be received before the customer calls a call center or the telephone number and login credentials may be received in real-time during the telephone call from the customer.

A phone call may be received from the telephone number of the customer. The customer, during the telephone call, may be offered a discount for a good or service in exchange for a positive social media communication from the social media account of the customer to a social media account of the business.

An acceptance may be received from the customer, during the telephone call, for the discount for the good or service in exchange for the positive social media communication from the social media account of the customer to the social media account of the business. The acceptance from the customer may be verbal or received by the customer pressing a particular number on the customer's phone (landline, cell or any other voice communication device, as non-limiting examples). The login credentials for the social media account of the customer may be read from the database. The positive social media communication from the social media account of the customer to the social media account of the business may be communicated using the login credentials for the social media account of the customer read from the database as described in the other embodiments.

As in the other embodiments, a most frequently used social media account for the customer may be determined from a plurality of social media accounts of the customer and the positive social media communication from the most frequently used social media account of the customer may be communicated to the matching social media account of the business.

The above features and advantages of the present invention will be better understood from the following detailed description taken in conjunction with the accompanying drawings.

### BRIEF DESCRIPTION OF THE DRAWINGS

FIG. 1 is a block diagram of a system for offering customers discounts online for goods or services in exchange for a positive social media interaction from the customer's social media account to the business' social media account.

FIG. 2 is a block diagram of a system for offering customers discounts via a phone for goods or services in exchange for a positive social media interaction from the customer's social media account to the business' social media account.

FIG. 3 is a flow diagram illustrating a possible embodiment implemented by a website hosting provider.

FIG. 4 is a flow diagram similar to FIG. 3, but including the steps receiving an acceptance from a customer and communicating the positive social media communication.

FIG. 5 is a flow diagram similar to FIG. 3, but includes the steps of determining and using the most frequently used social media account of the customer.

FIG. 6 is a flow diagram similar to FIG. 3, but includes the step of storing login credentials of customers in a database.

FIG. 7 is a flow diagram similar to FIG. 3, but includes the step of providing an administration interface to allow a business to select a discount deal in exchange for a positive social media communication.

FIG. 8 is a flow diagram illustrating a possible method of a business to offer a discount to customers online in exchange for positive social media communications.

FIG. 9 is a flow diagram similar to FIG. 8, but includes the step of determining and using the most frequently used social media account of the customer.

FIG. 10 is a flow diagram similar to FIG. 8, but includes the steps of storing and later reading login credentials of customers in a database.

FIG. 11 is a flow diagram similar to FIG. 8, but includes the step of receiving customer login credentials and logging into the social media account of a customer to communicate a positive social media from the customer's social media account to the business' social media account.

FIG. 12 is a flow diagram illustrating a possible method of a business to offer a discount to customers over a phone in exchange for positive social media communications.

FIG. 13 is a flow diagram similar to FIG. 12, but includes the step of logging into the customer's social media account using login credentials stored in a database.

FIG. 14 is a flow diagram similar to FIG. 12, but includes the steps of determining and using the most frequently used social media account of the customer.

### DETAILED DESCRIPTION

The present inventions will now be discussed in detail with regard to the attached drawing figures that were briefly described above. In the following description, numerous specific details are set forth illustrating the Applicant's best mode for practicing the invention and enabling one of ordinary skill in the art to make and use the invention. It will be obvious, however, to one skilled in the art that the present invention may be practiced without many of these specific details. In other instances, well-known machines, structures, and method steps have not been described in particular detail in order to avoid unnecessarily obscuring the present invention. Unless otherwise indicated, like parts and method steps are referred to with like reference numerals.

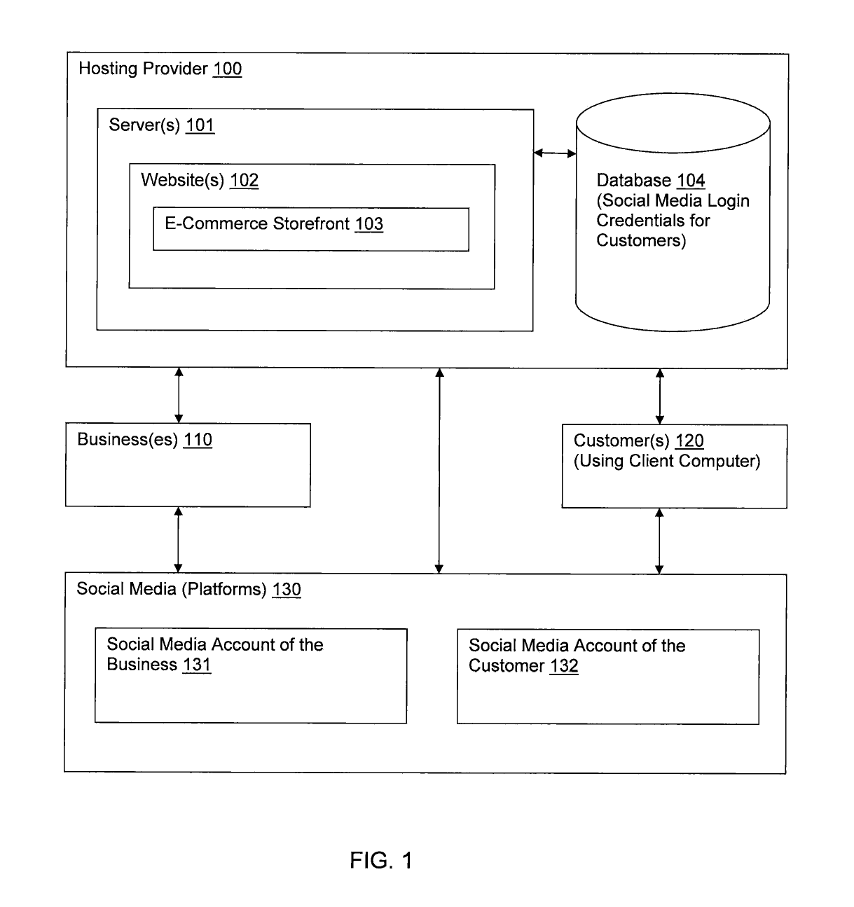

FIG. 1 is a block diagram of a system that may be used to practice the present invention. While only one hosting company 100, website 102, business 110, customer 120 and social media 130 are illustrated to simplify the process of describing the present invention, the invention is not so limited and in practice a hosting provider 100 may host 1,000s (or more) websites 102 and communicate with any number of different businesses, customers and social media (also known as social media platforms).

The arrows in FIG. 1 represent networks that allow, as examples, the hosting company 100, website 102, business 110, customer 120 and social media 130 to communicate with each other. A network may be a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, wireless networks, cell phone networks and/or combinations thereof. The invention may be used with any known or later developed type of network.

The Internet is a worldwide network of computers and networks arranged to allow the easy and robust exchange of information between people on client computers running browsers. Hundreds of millions of people (acting as businesses 110 and/or customers 120) around the world have access to computers connected to the Internet via Internet Service Providers (ISPs).

Content providers (which may be businesses 110) place multimedia information (e.g., text, graphics, audio, video, animation, and other forms of data) at specific locations on the Internet that may be referred to as a website 102. The combination of all the websites 102 and their corresponding web pages on the Internet is generally known as the World Wide Web (WWW) or simply the Web.

For businesses 110 and customers 120, the Internet continues to be increasingly valuable. Customers 120 use the Internet for everyday tasks, from social networking, shopping, banking, and paying bills to consuming media and entertainment. E-commerce is growing, with businesses 110 delivering more goods, services and content across the Internet, communicating and collaborating online, and inventing new ways to connect with each other. Each online business 110 may have one or more websites 102.

A website 102 may also include an e-commerce storefront 103 (also known as an electronic storefront or an online storefront). An e-commerce storefront 103 is an e-commerce solution for businesses 110 that want to host a website 102 that advertises products and/or services and for which customer transactions are generated online. Various software applications that provide the functionality of an e-commerce storefront 103 are available to businesses 110, which range from electronic shopping carts to secure payment gateways.

Product display, online ordering software, inventory management applications, billing and online payment system, and/or payment processing software may be included in an e-commerce storefront 103. Web analytics and secure socket layer (SSL) security may also be included in an e-commerce storefront 103. The e-commerce storefront 103 may also include the feature of a shopping cart interface. A shopping cart interface may operate in conjunction with customer check-out software. The e-commerce storefront 103 may include analytic interfaces for the purpose of growing online businesses 110 as well as predictive analytics to anticipate future shopping trends.

Prevalent on the Internet are websites 102 which offer and sell goods and services to individuals and organizations (customers 120). The websites 102 may consist of a single webpage, but typically consist of multiple interconnected and related webpages. Websites 102 may reside on one or more servers 101 that may be geographically separated to assist in load balancing and shortening communication delays caused by geographic distances between websites 102 and customers 120. Menus, links, tabs, etc. may be used by customers 120 to move between different web pages within the website 102 or to move to a different website altogether.

Websites 102 may be created using website code, which may comprise, as a non-limiting example, HyperText Markup Language (HTML) to generate a standard set of tags that define how the webpages for the websites 102 are to be displayed.

Customers 120 may access online businesses' websites 102 using software known as an Internet browser, such as MICROSOFT INTERNET EXPLORER, MOZILLA FIREFOX or GOOGLE CHROME. After the browser has located the desired webpage, the browser may request and receive information from the website 102, typically in the form of an HTML document, and then display the website content for the customer 120. The customer 120 may then view other webpages at the same website 102 or move to an entirely different website using the browser.

The websites 102 may be hosted or operated by one or more servers 101 which are preferably hosting services. The one or more servers 101 may be, as non-limiting examples, one or more Dell PowerEdge(s) rack server(s), HP Blade Server(s), or IBM Rack or Tower server(s), although other types or combination of servers may also be used. The one or more servers 101 comprise the electronic hardware to run computer programs that may be written to perform various functions, processes, methods and steps of the present invention.

Some online businesses 110, typically those that are larger and more sophisticated, may provide their own hardware, software, and connections to the Internet to operate their own websites 102. However, many businesses 110 either do not have the resources available or do not want to create and maintain the infrastructure necessary to host their own websites 102. To assist such businesses 110, hosting providers 100 exist that offer hosting services to websites 102 of businesses 110. These hosting providers 100 typically provide the hardware, software, and electronic communication equipment necessary to connect multiple websites 102 to the Internet. A single hosting provider 100 may literally host thousands or millions of websites 102 on one or more servers 101.

A database 104, 204 may be an organized collection of data. The data are typically organized to model relevant aspects of reality in a way that supports processes requiring this information. In the present invention, the database 104, 204 may be any type of database. The database 104, 204 may store, associate related data and permit the data to be read. The database 104, 204 may store, as non-limiting examples, customers' names, telephone number(s), social media login credentials and information regarding how frequently the customer 120 uses each type of social media 130.

Database management systems (DBMSs) are specially designed software applications that interact with the user, other applications, and the database 104, 204 itself to capture and analyze data. A general-purpose DBMS is a software system designed to allow the definition, creation, querying, update, and administration of databases 104, 204. Well-known DBMSs that may be used, as non-limiting examples, include MySQL, MariaDB, PostgreSQL, SQLite, Microsoft SQL Server, Microsoft Access, Oracle, SAP HANA, dBASE, FoxPro, IBM DB2, LibreOffice Base, FileMaker Pro and InterSystems Cache.

Social media 130 is typically driven by social interactions among people (this may include both businesses 110 and customers 120) in which the people create, share or exchange information and ideas in virtual communities over networks. Social media 130 may utilize a group of Internet-based applications that allow the creation and exchange of user-generated content. Social media 130 may also use mobile and web-based technologies to create highly interactive platforms through which individuals and communities share, co-create, discuss, and modify user-generated content. Non-limiting examples of social media 130 include Facebook, Twitter, Linkedln, Pinterest, Google Plus+, Tumblr, Instagram, VK, Flickr, MySpace, Meetup, Tagged, Ask.fm, MeetMe and Classmates.

A customer 120 that desires to use a particular flavor of social media 130 will typically have to register with that particular social media 130 and obtain a social media account of the customer 132. Login credentials, necessary to activate the social media account of the customer 132, are typically provided to the customer 120 at the end of the registration process with the social media 130. The login credentials typically comprise a user name and a password, although the present invention is not limited to any particular social media flavor or type of login credentials.

Businesses 110 and customers 120 may have accounts with one or more different social media 130. It may be beneficial for businesses 110 to build their social media 130 presence in order to build and enhance their brand and increase the business' 110 sales. Enhancing a brand may be done a number of different ways, depending on the particular social media 130 platform being used. As a non-limiting example, a social media account of a customer 132 may send a positive social media communication to the social media account of the business 131.

As non-limiting examples of positive social media communications, some social media 130 permit social media accounts to “follow” or “like” each other. It may be highly advantageous for a business 110 to get as many social media accounts of customers 132 to follow or like the social media account of the business 131 as possible.

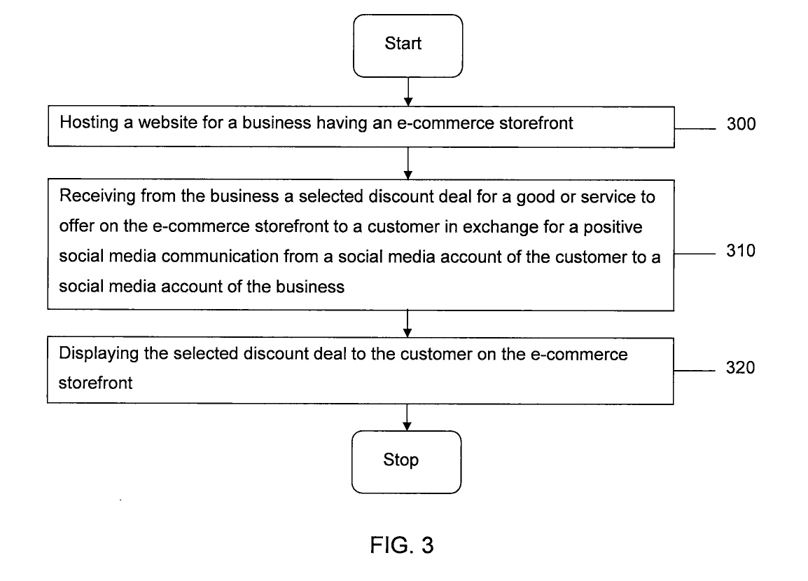

FIG. 3 illustrates one possible embodiment of the present invention. In this embodiment a hosting provider 100 may allow a business 110 to trade discounts for goods and services to customers 120 in exchange for a positive social media communication from the social media account of the customer 132 to the social media account of the business 131. In some embodiments, a hosting provider 100 may host a website 102 for a business 110. (Step 300) The website 102 may have an e-commerce storefront 103, preferably provided by the hosting provider 100 but may also come from a third party, from which the business 110 may sell goods and services.

The hosting provider 100 may receive from the business 110 a selected discount deal to offer for a good or service in exchange for a positive social media communication from a social media account of the customer 132 to a social media account of the business 131. (Step 310)

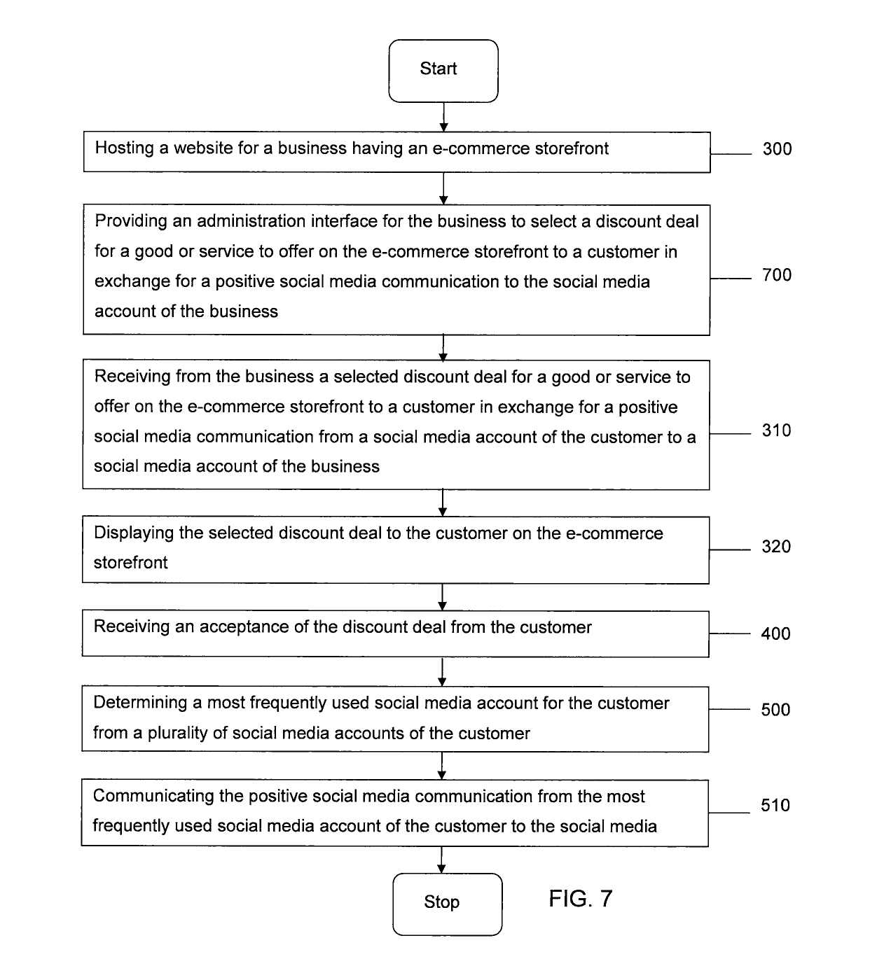

As illustrated in FIG. 7, the hosting provider 100 may provide an administration interface for the business 110 to select a discount deal for the good or service to offer on the e-commerce storefront 103 to the customer 120 in exchange for the positive social media communication from the social media account of the customer 132 to the social media account of the business 131. (Step 700) The selected discount deal may then be displayed to customers 120 on the e-commerce storefront 103. (Step 320)

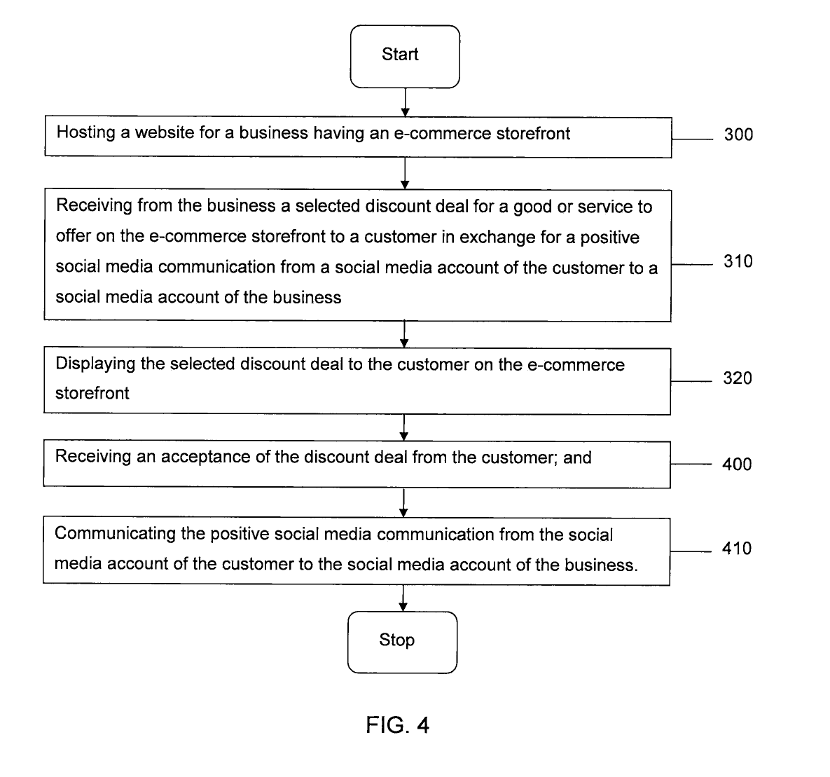

FIG. 4 illustrates another possible embodiment that includes the method of FIG. 3, but includes additional steps. Specifically, the website 102 or e-commerce storefront 103 may receive an acceptance of the discount deal from the customer 120 if the customer 120 desires to accept the discount deal. (Step 400) The website 102 or e-commerce storefront 103 may communicate the positive social media communication from the social media account of the customer 132 to the social media account of the business 131. (Step 410)

Communicating the positive social media communication from the social media account of the customer 132 to the social media account of the business 131 may be accomplished, as a non-limiting example, by the customer 120 providing the customer's login credentials to the website 102 or e-commerce storefront 103 and the website 102 or e-commerce storefront 103 logging into the social media account of the customer 132 using the customer's login credentials. The website 102 or e-commerce storefront 103 may then communicate the positive social media communication from the social media account of the customer 132 to the social media account of the business 131. The login credentials may comprise, as non-limiting examples, a user name and a password.

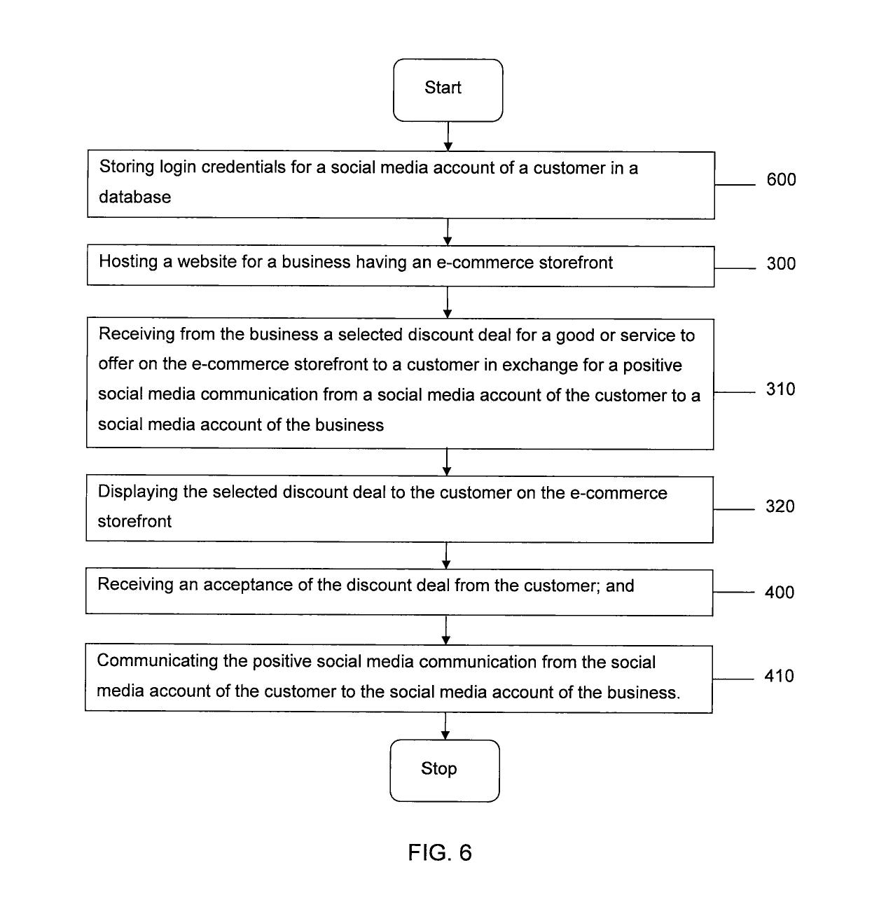

FIG. 6 illustrates another possible embodiment. Communicating the positive social media communication from the social media account of the customer 132 to the social media account of the business 131 may be accomplished, as a non-limiting example, by having the customer's login credentials, previously received from the customer 120, stored in a database 104. (Step 600) The website 102 or e-commerce storefront 103 may then log into the social media account of the customer 132 using the customer's login credentials and communicate the positive social media communication from the social media account of the customer 132 to the social media account of the business 131.

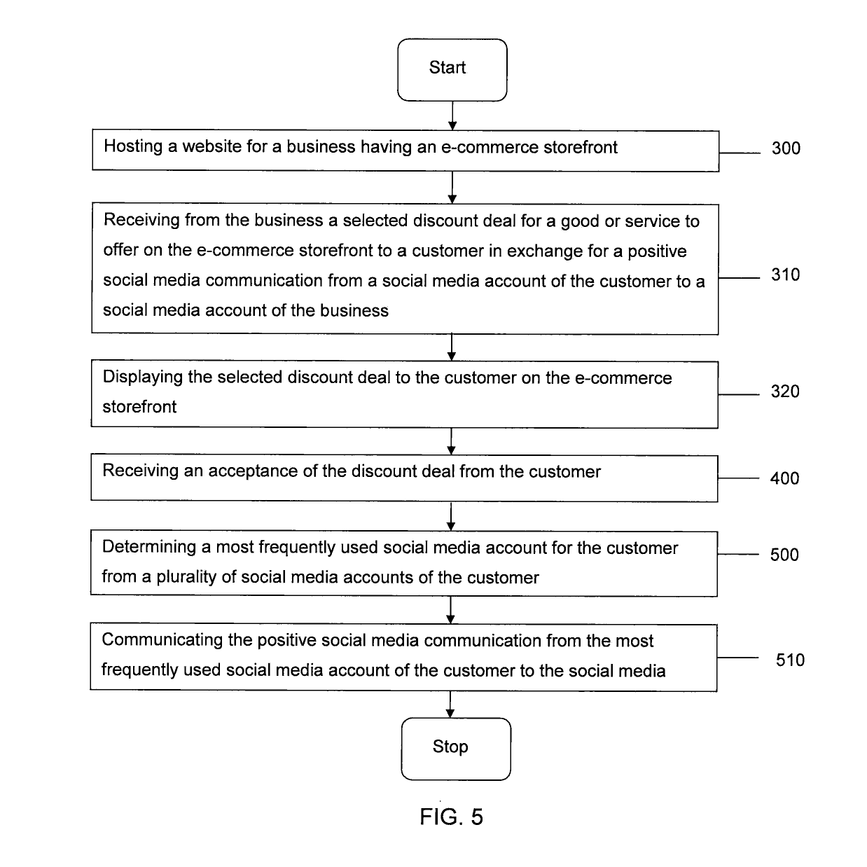

FIG. 5 illustrates another embodiment of the present invention. A most frequently used social media account for the customer 132 may be determined from a plurality of social media accounts of the customer 132. (Step 500) Software may be used to track the use of social media 130 by the customer 120 and the business 110. The positive social media communication may then be communicated from the most frequently used social media account of the customer 132 to the matching social media account of the business 131. (Step 510)

The positive social communication may be based on the possible types of communication permitted by the platform of the social media 130. As non-limiting examples, some social media 130 permit a social media account 131, 132 to “like” or “follow” another social media account 131, 132. However, the invention is not so limited and may use any positive social media communication permitted by a social media 130.

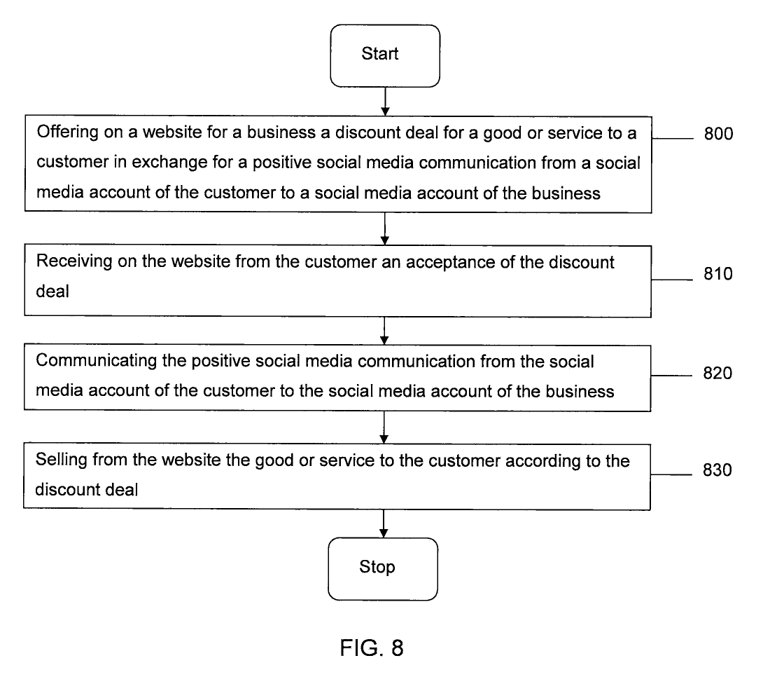

FIG. 8 illustrates another possible embodiment. A business 110 may offer on its website 102 a discount deal for a good or service to a customer 120 in exchange for a positive social media communication from a social media account of the customer 132 to a social media account of the business 131. (Step 800) In preferred embodiments, the website 102 includes an e-commerce storefront 103. The website 102 may receive from the customer 120 an acceptance of the discount deal. (Step 810) After receiving the acceptance, and only after receiving the acceptance, the website 102 may communicate the positive social media communication from the social media account of the customer 132 to the social media account of the business 131 (Step 820) and sell from the website 102 the good or service to the customer 120 according to the discount deal (Step 830).

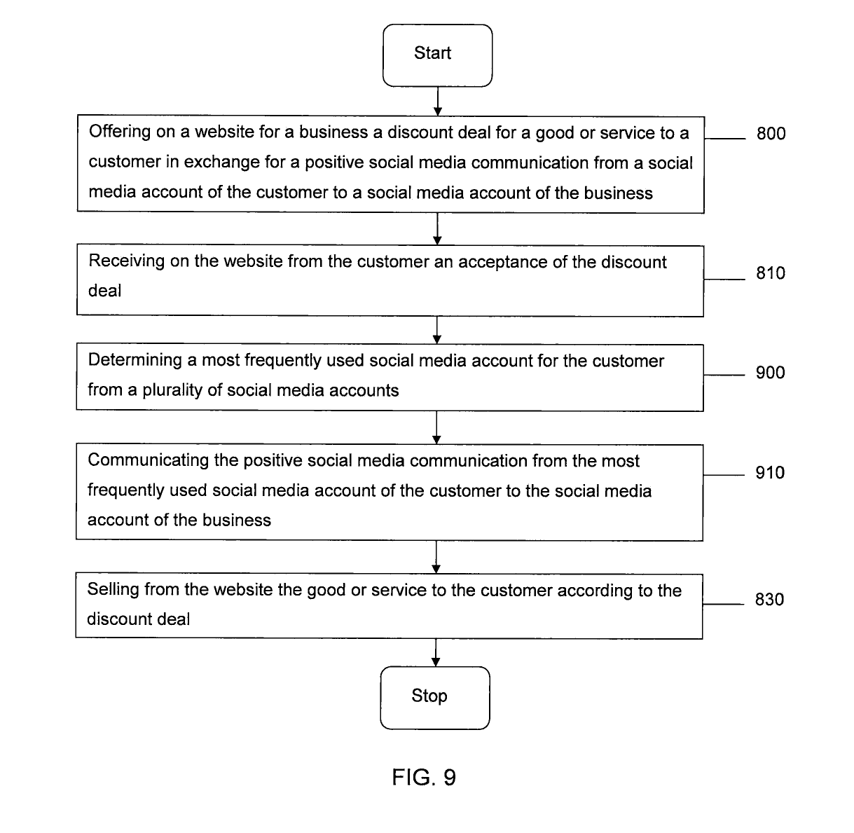

FIG. 9 illustrates another embodiment of the present invention. As in the previous embodiment, a most frequently used social media account of the customer 132 may be determined from a plurality of social media accounts of the customer 120. (Step 900) The positive social media communication from the most frequently used social media account of the customer 132 may be communicated to the matching social media account of the business 131. (Step 910) As in other embodiments, the positive social media communication is only limited by the types of communications permitted by the particular social media 130, but may comprise a like or a follow.

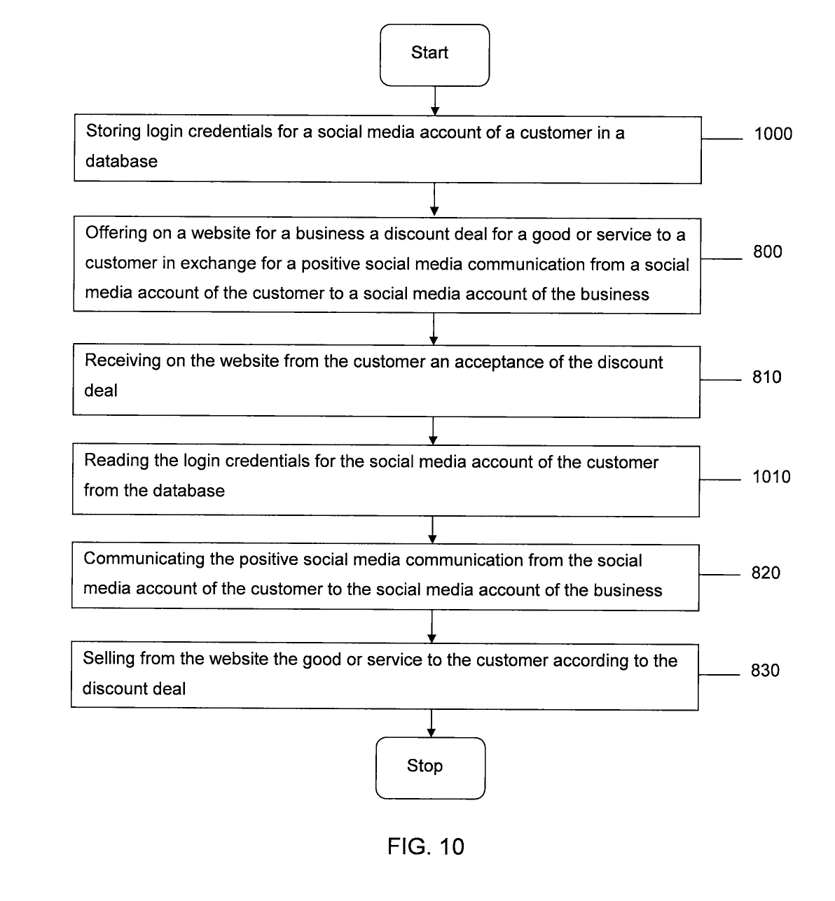

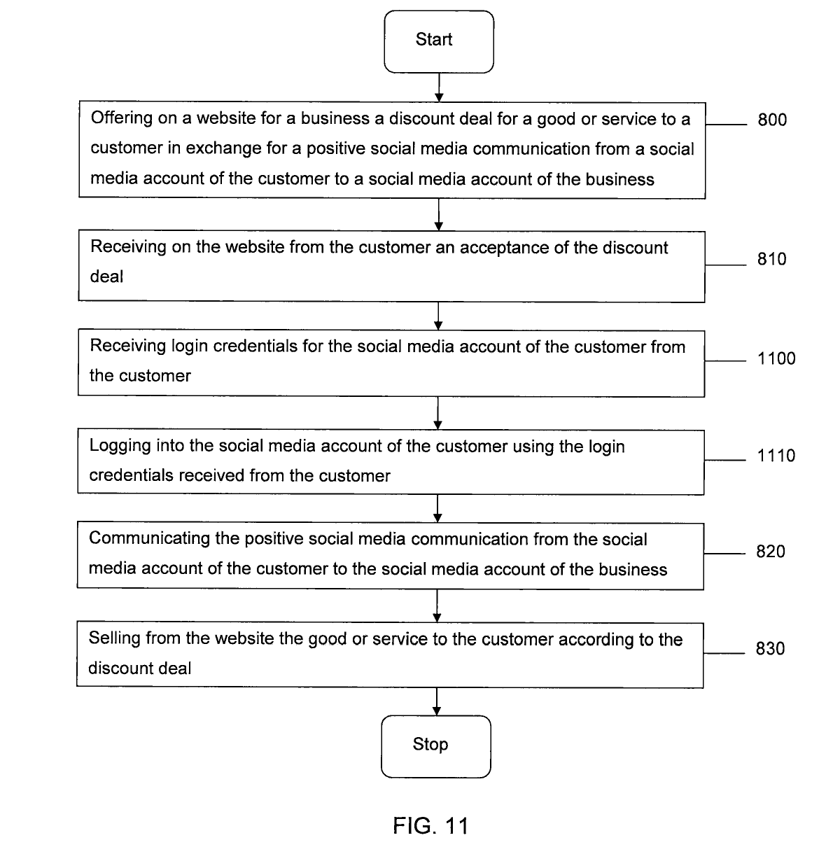

FIGS. 10 and 11 illustrate additional embodiments of the present invention. As discussed in previous embodiments, the login credentials for the social media account of the customer 132 may be received directly from the customer 120 (Step 1100) or may have been received from the customer 120 in the past and stored in a database 104 (Step 1000). Storing the login credentials permit the login credentials for the social media account of the customer 132 to be read when needed, i.e., after the customer 120 accepts the discount deal. (Step 1010) The login credentials may then be used to login into the social media account of the customer 132 (Step 1110) and transmit the positive social media communication from the social media account of the customer 132 to the social media account of the business 131.

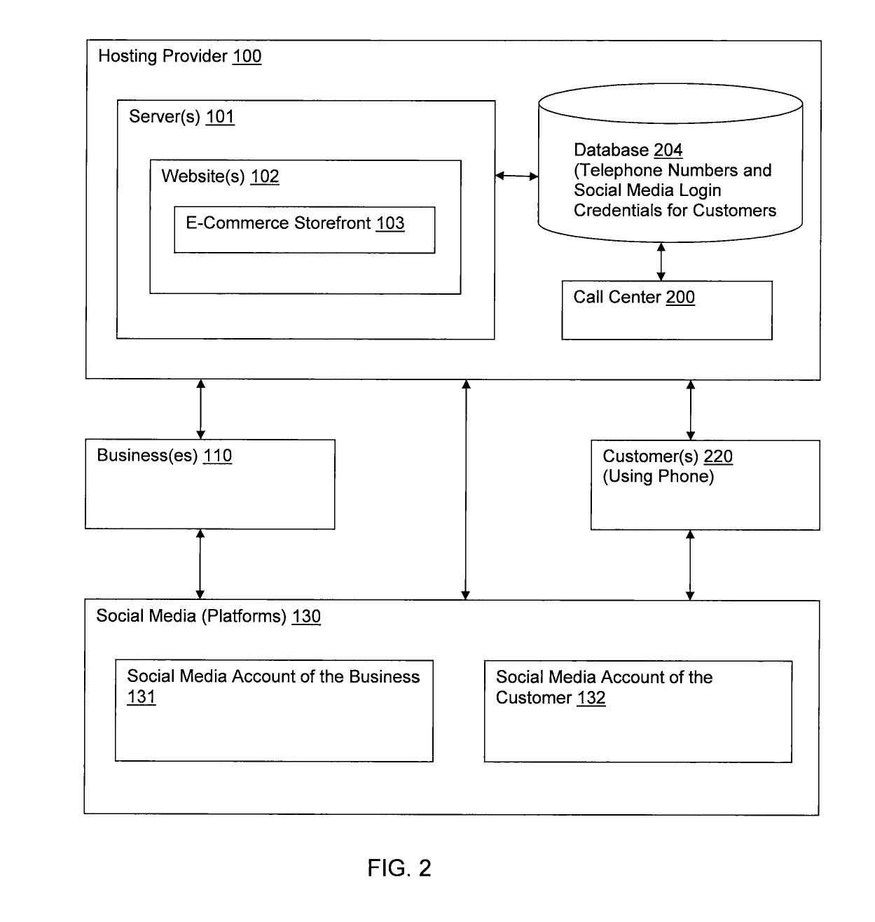

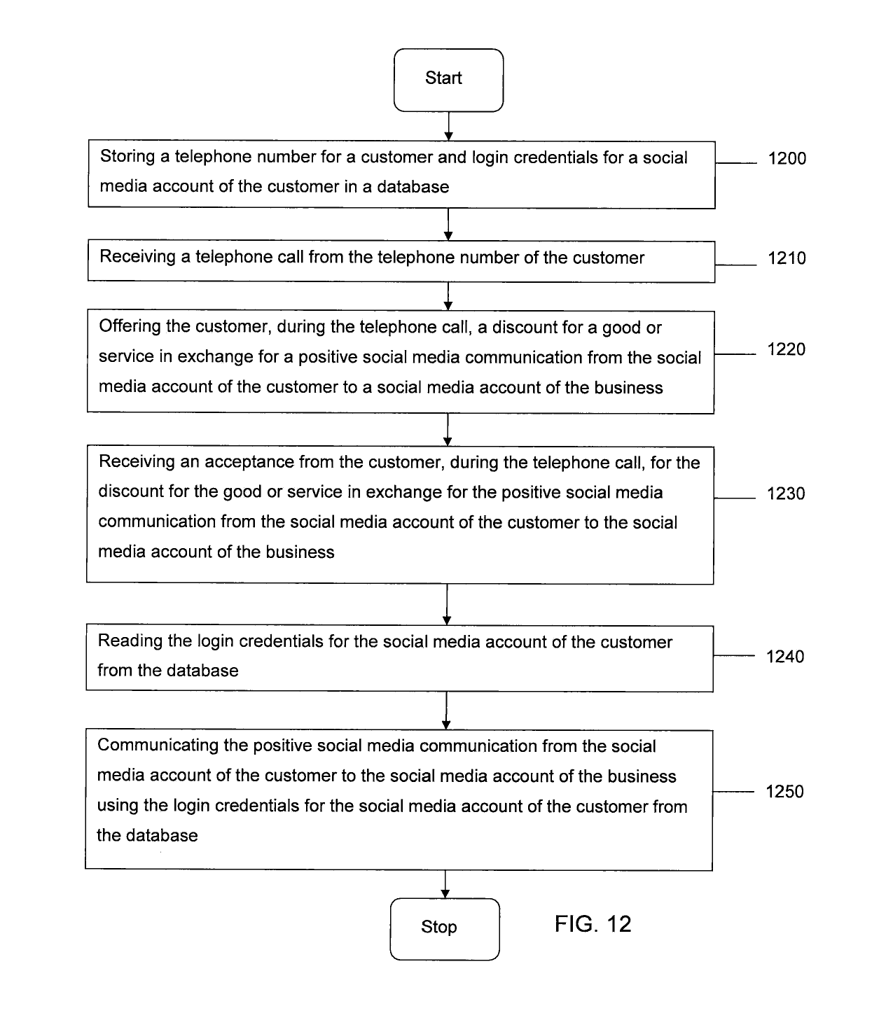

In another embodiment illustrated in FIGS. 2 and 12, a telephone number for a customer 220 and login credentials (such as a user account name and a password) for a social media account of the customer 132 may be stored in a database 104. (Step 1200) The customer's telephone number and login credentials may be received before the customer 220 calls a call center 200 or the telephone number and login credentials may be received in real-time during the telephone call by the customer 220 to the call center 200.

The phone call may be received from the telephone number of the customer 220. (Step 1210) The customer 220 may use any type of phone (landline, cell phone, etc.) now known or developed in the future. The customer 220, in real-time during the telephone call, may be offered a discount for a good or service in exchange for a positive social media communication from the social media account of the customer 132 to a social media account of the business 131. (Step 1220)

An acceptance may be received from the customer 220, during the telephone call, for the discount for the good or service in exchange for the positive social media communication from the social media account of the customer 132 to the social media account of the business 131. (Step 1230)

The acceptance may be verbal from the customer 220 or received from the customer 220 by the customer 220 pressing a particular number or key on the customer's phone (which may be, as non-limiting examples, a landline or cell). The login credentials for the social media account of the customer 132 may be read from the database 104 (Step 1240) or provided by the customer 220 in real-time during the phone call. The positive social media communication from the social media account of the customer 132 to the social media account of the business 131 may be communicated using the login credentials for the social media account of the customer 132 from the database 104 as described in the other embodiments. (Step 1250)

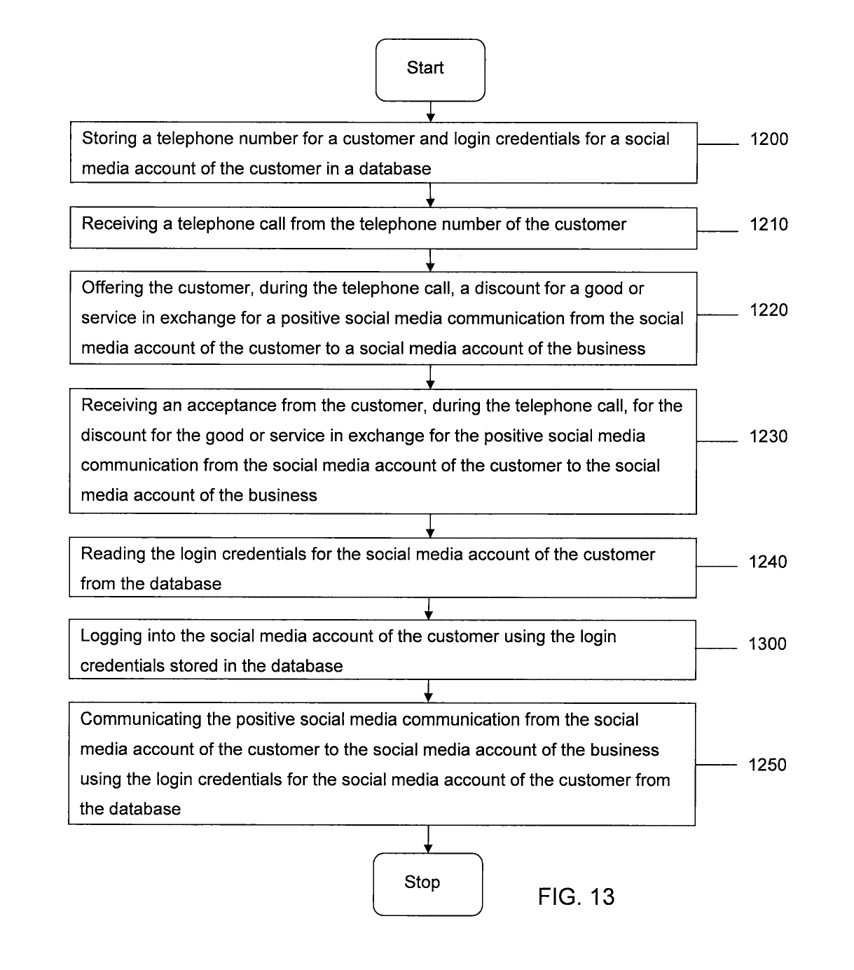

FIG. 13 illustrates an embodiment where the website 102 or e-commerce storefront 103 may log into the social media account of the customer 132 using the login credentials stored in a database 204. Once logged into the social media account of the customer 132, the website 102 or e-commerce storefront 103 may communicate a positive social media communication from the social media account of the customer 132 to the social media account of the business 131 in exchange for the discount deal. (Step 1300)

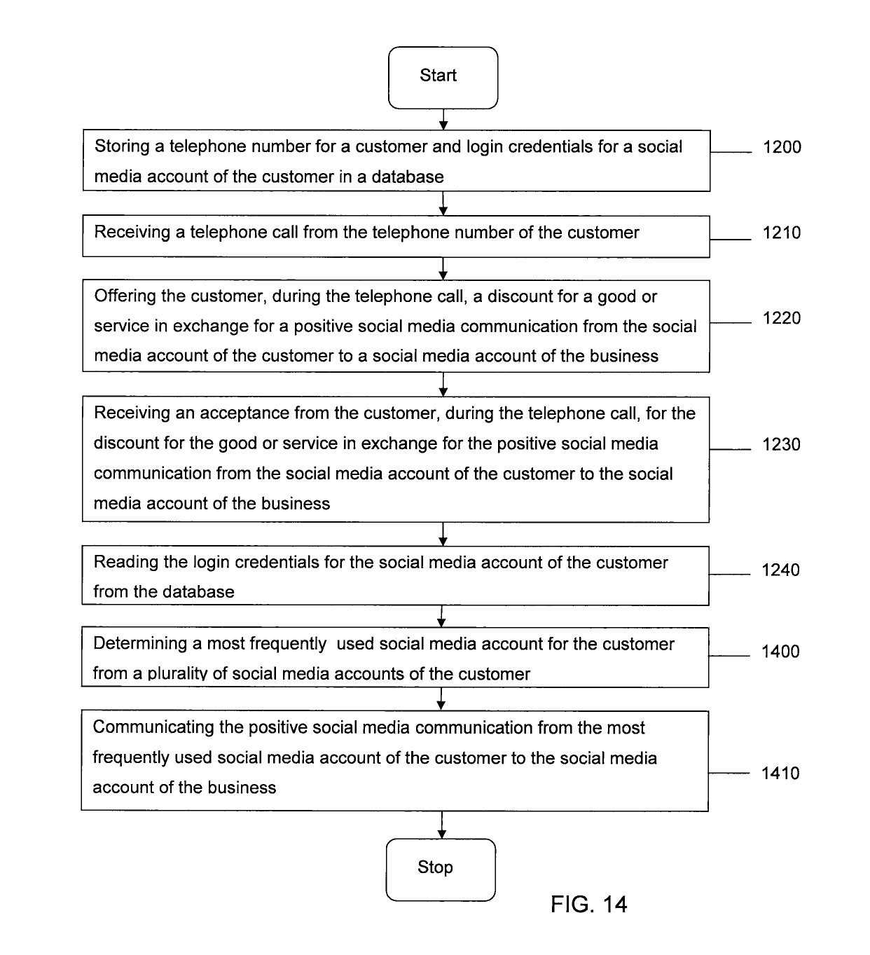

FIG. 14 illustrates another embodiment. In this embodiment a most frequently used social media account for the customer 132 may be determined from a plurality of social media accounts of the customer 220 (Step 1400) and the positive social media communication from the most frequently used social media account of the customer 132 may be communicated to a matching social media account of the business 131 (Step 1410).

Other embodiments and uses of the above inventions will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

The Abstract accompanying this specification is provided to enable the United States Patent and Trademark Office and the public generally to determine quickly from a cursory inspection the nature and gist of the technical disclosure and in no way intended for defining, determining, or limiting the present invention or any of its embodiments.

1. A method, comprising the steps of:
a) hosting, using one or more servers, a website for a business having an e-commerce storefront;
b) receiving, using the one or more servers, from the business a selected discount deal for a good or service to offer on the e-commerce storefront to a customer in exchange for a positive social media communication from a social media account of the customer to a social media account of the business; and
c) displaying, using the one or more servers, the selected discount deal to the customer on the e-commerce storefront.

2. The method of claim 1, further comprising the steps of:
d) receiving, using the one or more servers, an acceptance of the discount deal from the customer; and
e) communicating the positive social media communication from the social media account of the customer to the social media account of the business.

3. The method of claim 2, further comprising the steps of:
f) determining a most frequently used social media account for the customer from a plurality of social media accounts of the customer; and
g) communicating the positive social media communication from the most frequently used social media account of the customer to the social media account of the business.

4. The method of claim 2, wherein the positive social media communication comprises a follow selection of the social media account of the business from a social media account of the customer.

5. The method of claim 2, wherein the positive social media communication comprises a like selection of the social media account of the business from a social media account of the customer.

6. The method of claim 2, further comprising the step of:
f) storing login credentials for the social media account of the customer in a database.

7. The method of claim 2, further comprising the step of:
f) providing an administration interface for the business to select a discount deal for the good or service to offer on the e-commerce storefront to the customer in exchange for the positive social media communication to a social media account of the business.

8. A method, comprising the steps of:
a) offering on a website, hosted on one or more servers, for a business a discount deal for a good or service to a customer in exchange for a positive social media communication from a social media account of the customer to a social media account of the business;
b) receiving on the website from the customer an acceptance of the discount deal;
c) communicating the positive social media communication from the social media account of the customer to the social media account of the business; and
d) selling from the website the good or service to the customer according to the discount deal.

9. The method of claim 8, further comprising the steps of:
e) determining a most frequently used social media account for the customer from a plurality of social media accounts of the customer; and
f) communicating the positive social media communication from the most frequently used social media account of the customer to the social media account of the business.

10. The method of claim 8, wherein the positive social media communication comprises a follow selection of the social media account of the business from the social media account of the customer.

11. The method of claim 8, wherein the positive social media communication comprises a like selection of the social media account of the business from the social media account of the customer.

12. The method of claim 8, further comprising the steps of:
e) storing login credentials for the social media account of the customer in a database prior to step a); and
f) reading the login credentials for the social media account of the customer from the database prior to step c).

13. The method of claim 8, further comprising the steps of:
e) receiving login credentials for the social media account of the customer from the customer; and
f) logging into the social media account of the customer using the login credentials received from the customer prior to step c).

14. A method, comprising the steps of:
a) storing a telephone number for a customer and login credentials for a social media account of the customer in a database;
b) receiving a telephone call from the telephone number of the customer;
c) offering the customer, during the telephone call, a discount for a good or service in exchange for a positive social media communication from the social media account of the customer to a social media account of a business;
d) receiving an acceptance from the customer, during the telephone call, for the discount for the good or service in exchange for the positive social media communication from the social media account of the customer to the social media account of the business;
e) reading the login credentials for the social media account of the customer from the database; and
f) communicating the positive social media communication from the social media account of the customer to the social media account of the business using the login credentials for the social media account of the customer from the database.

15. The method of claim 14, wherein the login credentials for the social media account of the customer comprises a user name and a password.

16. The method of claim 14, further comprising the step of:
g) logging into the social media account of the customer using the login credentials stored in the database.

17. The method of claim 14, wherein the login credentials for the social media account of the customer are provided by the customer before the telephone call.

18. The method of claim 14, further comprising the steps of:
g) determining a most frequently used social media account for the customer from a plurality of social media accounts of the customer; and
h) communicating the positive social media communication from the most frequently used social media account of the customer to the social media account of the business.

19. The method of claim 14, wherein the positive social media communication comprises a follow selection of the social media account of the business from the social media account of the customer.

20. The method of claim 14, wherein the positive social media communication comprises a like selection of the social media account of the business from the social media account of the customer.
